(19) United States
(12) Patent Application Publication
(10) Pub. No.: US 2005/0153144 A1
(43) Pub. Date: Jul. 14, 2005

(54) Noble metal preparations and lustring preparations for direct and indirect screen printing

(75) Inventors: Annette Lukas, Rodenbach (DE); Sabine Wissel, Kahl/Main (DE); Gunter Werner, Hanau (DE); Patrick Wenzel, Haibach (DE); Johann Duchac, Maintal (DE)

Correspondence Address: Norris, McLaughlin & Marcus P.A.;18th Floor, 875 Third Avenue, New York, NY, 10022, US

(73) Assignee: W.C. Heraeus GmbH, Hanau (DE)

(21) Appl. No.: 11/010,724

(22) Filed: Dec. 13, 2004

(30) Foreign Application Priority Data
Dec. 17, 2003 (DE) 103 59 448.5
Apr. 6, 2004 (DE) 10 2004 017 335.4

(51) Int. Cl. B32B 15/00; C08K 5/00; B05D 5/00

(52) U.S. Cl. 428/434; 106/499; 427/258; 428/435

(57) ABSTRACT

Noble metal preparations or lustre preparations which contain at least one polyaminoamide whose amino groups have preferably been inactivated, have a particularly advantageous stability in storage.

The invention relates to noble metal preparations and lustring preparations and decalcomanias containing them which are preferably used in indirect and direct screen printing.

As a rule, noble metal preparations for decorating glass, ceramics, porcelain, bone china, tiles or other silicate-type substrates consist of solutions of organic gold compounds, palladium compounds and platinum compounds (which are usually dissolved in organic carrier materials), synthetic or natural resins as well as fluxes which ensure adhesion on the carrier material concerned. Usually, specific organic metal compounds, e.g. alcoholates, carboxylates, resinates or sulphoresinates of the elements rhodium, silver, chromium, bismuth, vanadium, silicon etc are used as fluxes. During firing, the organic compounds decompose to the corresponding oxides or metals thus producing the adhesion and optical properties of the metal film on the substrate.

Regarding the decoration of silicate-type substrates such as glass, ceramics, porcelain and bone china with ceramic pigments, a distinction is made in the type of application. Apart from decoration by hand using brush application, stamping, neoprene transfer, Netsch systems, tampon printing—direct and indirect—screen printing processes are also commonly used. Because of the diverse applications and advantages of screen printing, this process is one of those most commonly used at present. In this respect, a distinction is again made between direct and indirect screen printing. In direct screen printing, the substrate to be decorated is printed directly by means of a template and this process is repeated, if necessary, using further pastes. During indirect screen printing, a special paper is printed with a template which paper is either coated with a dextrin or a wax layer. This process has the advantage that it is possible to print several colours accurately on top of each other, thus producing sophisticated designs. In order to be able to apply the decorations thus produced, a varnish mask is required which can also be applied by screen printing. In the case of printing onto paper coated with dextrin—the decalcomanias thus produced are detached from the carrier paper by soaking in water or—in the case of printing onto the wax layer—by heating of the reverse side. Subsequently, the decorations are transferred onto the substrates concerned. In the former case, it is necessary to ensure that no water is present underneath the decalcomanias before firing (this would produce steam during heating which could tear holes into the decoration). In the latter case, a small amount of wax remains underneath the decalcomania, which burns during firing.

In EP 863 187131, section [0020], possible binders for liquid of paste-type decorative pigments are listed, including a series of homopolymers, copolymers and block copolymers—including polyamides—which, if necessary, may contain solubilising groups, including amino or ammonium groups.

In DE 101 46 684A1, amino resins are mentioned as binders for preparations for direct printing.

For direct and indirect screen printing, the preparations must exhibit certain properties and satisfy the requirements which are explained below in further detail.

Noble metal preparations containing polyamide and rosin, which are suitable for screen printing, have been described e.g. in DE 198 31 141 A1, DE 198 31 141 C2 and EP 514 073 A2. Such noble metal preparations tend to develop aging effects, i.e. the viscosity of the preparations increases in the course of the storage time, this being a function of the temperature. This can lead, in a relatively short time even at room temperature, to these products being unsuitable for the production of decalcomanias and becoming useless. During transportation and despatch to countries with high average temperatures, in particular, the preparations post-react more rapidly and become highly viscous. Moreover, many preparations tend to age also in the printed decalcomania in the form of embrittlement which becomes apparent by cracking during application and firing. Also not inconsiderable is the thickening of the products by oxidative reactions, which occurs in some cases during printing of the preparations and can arise, apart from an increase in viscosity, as a result of the loss of solvent.

Consequently, there exists a further requirement for preparations which do not exhibit the above-mentioned disadvantages and/or are more resistant to aging and the temperature.

It has been found that noble metal preparations containing polyaminoamides are, surprisingly enough, resistant to aging and satisfy, in an excellent manner, all further requirements which are made regarding pastes for—direct and indirect—screen printing.

Polyaminoamides are well known epoxide curing agents (publication of Bakelit-AG, page 5, column 3, DE 37 11 947 A1). “Polyaminoamide” is a generic term which describes compounds which contain several free (active) amino groups and at least one amide function per molecule (“International Organisation for Standardisation”). Essentially, they are reaction products of carboxylic acids or their esters with polyamines. Polyaminoamides are obtained primarily from the condensation reaction between a polymeric fatty acid such as a dimeric or trimertic acid, and a polyamine such as e.g. polyethylene polyamine. Since, in this example, the polymeric fatty acid is a mixture of e.g. 70 to 80% by weight of dimer, approximately 15 to 25% by weight of trimer and tetramer and less than 10% by weight of monomer, a quantity of different polyaminoamides is obtained which in turn depend on the type and quantity of the polyamine used. To this extent, it is impossible to indicate an accurate structural formula. Although formulae are indicated in the literature such as the following:
H₂N-A-[NH—CO-E-CO—NY—Y—]—NH₂ (1)
in which A and Y are the same or different and represent divalent aromatic or aliphatic groups and E also represents an aliphatic or aromatic divalent group, such formulae can only serve as an illustration and do not restrict the class of substances described above which is covered by the scope of the invention. Further examples of the class of compounds are described in detail e.g. in EP 654 465 A1.

Those representatives of the class of compounds of “polyaminoamides” can be considered for use according to the invention, above all, whose viscosity is compatible with their application in noble metal preparations.

A particular advantage of the use of polyaminoamides in bright noble metal preparations is that formulations can be produced entirely without the usual additions of natural resins (such as rosin or gum dammar). In this way one is, on the one hand, independent of quality variations to which such natural substances are subject. On the other hand, the binder systems which are known from the state of the art for preparations for indirect screen printing are produced from a relatively large number of components which need to be procured in a complicated/costly manner and mixed and/or chemically reacted.

The problem and/or the challenge in preparing a decalcomania paste, however, consists above all of the fact that the printed decalcomanias need to be highly flexible and elastic and must not be attacked by the varnish mask and the fact that the latter must not lead to any interference during firing. These characteristic properties have previously been achieved only by means of the complicated/expensive binder systems described above. According to the invention, this is made possible by adding a single class of resin.

Appropriately, use is made in the preparations of 3 to 50% by weight of polyaminoamide, preferably of 3 to 30% by weight, particularly preferably 3 to 20% of a conversion product of the polyaminoamide with an at least equimolar quantity of carboxylic acid in the presence of a solvent as described e.g. in example 1 or 4.

It is, moreover, advantageous to use the polyaminoamides in such a way that the amino functions are initially inactivated or partly inactivated since it is possible for an undesirable polymerisation to be caused by the free amino groups in combination with the organometal moieties of the noble metal preparation. In this connection, it can also be advantageous to add, in a quantity in excess of the stochiometric ratio, an inactivator which blocks the amino groups.

The inactivators are appropriately used in a quantity which is equimolar to the free amino groups; however, it is also possible for a slight shortfall or excess to as much as large excesses, e.g. a 2 to 5 fold molar excess, in particular a 2 to 4 fold excess, to be used.

In the simplest case, one possibility of blocking the amino groups is achieved by the protonated form. For this purpose, the polyaminoamide is used in a solvent containing an acid. Apart from the usual carboxylic acids such as acetic, formic, benzoic or citric acid, more exotic acids such as e.g. 2-ethyl hexyl carboxylic acid or furan carboxylic acid, but also dicarboxylic acids can be considered for this purpose. Moreover, a controlled quantity of an epoxide can also be used for the purpose of inactivation. The amino function is also inactivated by the reaction with the epoxy group.

Natural components which are, in any case, used in noble metal preparations such as e.g. sulphurised gum dammar and, surprisingly enough, even bases such as caustic soda solution are also suitable as inactivators. If used, the use of 6 to 20% of a 50% caustic soda solution is appropriate.

In addition to the polyaminoamides, the preparations according to the invention may contain the ingredients commonly used in this field, e.g. metal resinates, organometallic compounds, natural resins, synthetic resins, resin oils, organic pigments and fillers, thixotroping agents, solvents and defoaming agents.

The preparations contain e.g. one or several soluble compounds of the noble metals from the series of gold, silver, ruthenium, rhodium, palladium, osmium, iridium and platinum. However, addition in the elementary form is also possible. The noble metal compounds are usually present in the form of organic compounds in which the noble metal is bound to an organic skeleton via a sulphur or oxygen bridge. Since mixtures of substances are frequently involved, these are referred to as noble metal resinates and noble metal sulphoresinates. The flux compounds are, in particular, resinates and sulphoresinates of elements of the third to fifth main group and the third to eighth group B of the periodic system. The carrier media usually consist of a combination of at least one solvent and one binder. The liquid carrier medium can be purely organic, organic-aqueous or essentially purely aqueous. The organic media are frequently those based on hydrocarbons, alcohols and sulphur-containing compounds such as sulphurised terpene hydrocarbons and terpene alcohols as well as sulphurised natural resins which then serve simultaneously as binders and influence the optical and mechanical properties of the fired decorations and play an essential part regarding the processing properties of the preparations.

The noble metal content of the preparations is usually in the region of 6 to 16% by weight of noble metals, based on the preparation, preferably in the region of 8 to 15% by weight and particularly preferably in the region of 9 to 12% by weight.

In the case of the lustre preparation, the noble metal content is less than 6% or, depending on the tint and the composition, a product free from noble metal can be involved.

The noble metal compounds contained in the bright noble metal preparations according to the invention are organic compounds which are soluble in the organic, organic-aqueous or essential aqueous medium present. The organic noble metal compounds are in particular those in which the noble metal is bound to an organic skeleton via a sulphur or oxygen bridge. In particular, socalled sulphoresinates which are the result of the reaction of a gold compound with a sulphurised resin-type compound, and thioesters and in particular thiolates based on aliphatic, cycloaliphatic and aromatic mercaptans are involved. Insofar as the noble metal preparation contains an aqueous or organic-aqueous medium, the organic noble metal compound additionally exhibits solubilising groups from the series of —COOH—, —SO₃H, —OH, —CONH₂, —NH₂ and OP(O)(OH)₂. Organic noble metal compounds soluble in an organic carrier medium are generally known to those skilled in the art; as an example, reference should be made to the documents quoted in the introduction. Gold compounds soluble in an aqueous-organic carrier medium are known from EP-B 0 514 073 and EP-B 0 668 265.

Apart from the organic noble metal compounds, the preparations according to the invention may contain organic and/or inorganic non-noble metal compounds which are soluble in the preparation and form the corresponding elemental oxide under the conditions of firing. The selection of the organic or inorganic remainder of these non-noble metal compounds can take place freely for as long as the compound is homogeneously soluble in the carrier medium selected and the compound is capable of decomposing without residue during firing to form the elemental oxide. Similar to the noble metal compounds, low molecular alcoholates and thiolates and so-called resinates and sulphoresinates can be involved in this case. Some flux elements, including cobalt and chromium, can also be used in the form of salts of aliphatic or aromatic carboxylic acids such as ethyl hexanoates or octanoates or complexes with aliphatic diketones such as e.g. pentane dionates or mixtures of these compounds. Inorganic fluxes can be used in preparations with an aqueous or aqueous-organic medium. Organic and/or inorganic non-noble metal compounds as a rule contain metal ions of groups 3a and b, 4a and b, 5a and b, 6b, 7b, 8b, 1b and 2b. Noble metal preparations can thus exhibit at least one further element from the group of Ru, Si, Zr, V, Cr, Os, Ni, Mn, Fe, Co, Bi, W, Ce, Ta, Mo, Ba, B, Pb, Ge, Ca, Ir, Al, Ti, Cu, Sn, Zn, Ga in the form of organic and/or inorganic compounds which serve the purpose of modifying the lustre and tint properties and improving the mechanical and chemical resistance. Preferably, one or several compounds of the elements of the series of boron and aluminium; indium, scandium, yttrium, lanthanum, cerium; chromium and silicon, germanium and tin; titanium and zirconium; bismuth; vanadium, niobium and tantalum; iron and copper, for example, are preferred in the case of lustre preparations. Although rhodium belongs to the noble metals, rhodium compounds have a flux effect.

Those carrier media can be considered for use such as those known for previously known noble metal preparations with an organic or organic-aqueous medium. Usually, the carrier medium comprises both an organic binder and an organic, organic-aqueous or essentially purely aqueous solvent. The composition of the carrier medium and the application quantity thereof are selected in such a way that the organic noble metal compounds and organic non-noble metal compounds are soluble therein giving a clear solution and the preparation exhibits a viscosity suitable for the type of application selected and good film properties of the dried but not yet fired film. Preferably, the organic noble metal compounds and organic non-noble metal compounds still form a homogenous system and/or a solution after drying. The binder or binders present should be dissolved in the solvent or solvent mixture present to give as clear a solution as possible. Known binders for bright noble metal preparations are polyacrylic and polymethacrylic resins, polyvinyl pyrrolidone, cellulose ethers such as hydroxyalkyl cellulose, alkoxy cellulose and carboxyalkyl cellulose, polyamides, polyalkylene glycols such as polyethylene glycol, polyesters, polyacrylamides, polyvinyl acetate, polyvinyl alcohol, alkyl resins, polyamines, polyurethane resins, hydrocarbon resins, urea formaldehyde resins, modified urea formaldehyde resins, melamine resins, alkyd resins, polyurethane resins or epoxy resins (or their mixtures) as well as natural resins and sulphurised natural resins such as sulphurised gum dammar, asphalt, rosin, rosin esters, rosin-modified resins, amino resins based on natural substances, nitrocellulose, ketone resins, sulphurised turpene resins.

Noble metal preparations with an essentially organic carrier medium generally contain 10 to 40% by weight of one or several organic solvents. Aliphatic, cycloaliphatic and aromatic hydrocarbons, in particular alkylated aromatics and terpene hydrocarbons, ketones, alcohols and ethers are suitable; ethereal oils are also highly suitable.

Effective binder components are also maleic acid, modified rosin resins and rosin-modified phenol resins. Waxes from the series of fatty alcohols, fatty amides, polyolefin waxes and polyalkylene glycols are also suitable as binders. Usually, non-aqueous bright noble metal preparations contain an organic carrier medium containing one or several binders and one or several organic solvents in a total quantity of approximately 20 to 60% by weight, based on the preparation.

The bright noble metal preparations can be produced in the usual way by homogenising the organic noble metal compounds, flux compounds and carrier medium containing solvent and/or binder. The production can additionally comprise a sulphurisation step whereby unsaturated binder and/or solvent and, if necessary, noble metal compounds are crosslinked via sulphur bridges. Application and firing conditions are detailed in the following.

It is, moreover, possible to produce preparations by reactions and additions of further resins (of synthetic or natural origin—e.g. asphalt) which preparations are optimised and further improved regarding the tint and the mechanical and chemical resistance of the decorations produced therefrom. The same applies to organometallic compositions. This relates to both the field of gloss and lustre, polishing and silk matt preparations.

Polyaminoamides suitable for the formulations are, for example, Aradur 100 BD or Aradur 350 BD from Vantico, Basle.

The following example illustrates the pretreatment of the polyaminoamide:

### EXAMPLE 1

A solution of 26% isopropanol, 24% ethylhexanoic acid and 50% polyaminoamide curing agent Aradur 100 BD (Vantico) is treated for ½ h at 120° C. The resulting solution is used directly in a recipe for a noble metal preparation.

To illustrate particular embodiments of the invention, recipes for bright noble metal preparations for glass and porcelain/ceramics are described in further examples (figures in % are % by weight).

| Example 2: For porcelain | | % |
|---|---|---|
| Gold sulphoresinate | (54% Au) | 22.2 |
| Silver sulphoresinate | (52° /a Ag) | 2.88% |
| Rhodium resinate, dissolved in pine oil | (5% Rh) | 2.0 |
| Silicon resinate, dissolved in pine oil | (10% Si) | 1.5 |
| Bismuth resinate | (10% Bi) | 0.5 |
| Polyaminoamide resin (50% in solution ac- | | 20.0 |
| cording to example 1) | | |
| Pine oil | | 48.60 |
| Thixotroping agent | | 2.0 |
| Defoaming agent | | 0.3 |
| Example 3: For glass | | % |
| Gold sulphoresinate | (54% Au) | 22.2 |
| Silver sulphoresinate | (52% Ag) | 2.88% |
| Rhodium resinate, dissolved in pine oil | (5% Rh) | 2.0 |
| Silicon resinate, dissolved in pine oil | (10% Si) | 1.5 |
| Chromium hexanoate | (10% Cr) | 0.5 |
| Vanadium resinate, dissolved in pine oil | (3% V) | 1.0 |
| Polyaminoamide resin (50% in solution ac- | | 20.0 |
| cording to example 1) | | |
| Pine oil | | 48.60 |
| Thixotroping agent | | 2.0 |
| Defoaming agent | | 0.3 |

The pastes thus produced are printed with a 400 mesh steel fabric, dried and varnished with a varnish mask (polyester fabric 32, varnish L 406 from Heraeus). After drying of the varnish mask, the decoration can be fired after application.

### EXAMPLE 4

Conversion of Aradur 100 BD (Vantico) with 2-furan carboxylic acid and subsequent conversion and reaction with remaining paste components:

| | |
|---|---|
| Aradur 100 BD | 10.00% |
| Pine oil (equalising component) | 56.18% |
| Furan carboxylic acid | 3.50% |

Conversion at 130° C. for 30 min and subsequent addition of

| | | |
|---|---|---|
| Gold sulphoresinate | (54% Au) | 22.20% |
| Silver sulphoresinate | (52% Ag) | 2.12% |
| Rhodium resinate, dissolved in pine oil | (5% Rh) | 1.0% |
| Silicon resinate, dissolved in pine oil | (10% Si) | 2.0% |
| Bismuth resinate | (10% Bi) | 1.0% |
| Sulphurised gum dammar | | 2.0% |

The paste is gelled by brief reaction at 125° C.

### EXAMPLE 5

Conversion of Aradur 350 BD (Vantico) with 2-furan carboxylic acid:

| | |
|---|---|
| Aradur 350 BD | 43.00 |
| Furan carboxylic acid | 4.80 |
| Pine oil (equalisation component) | 52.20 |
| Reaction at 130° C. for 30 min. | |

### EXAMPLE 6

Reaction of Aradur 350 BD (Vantico) with sulphurised gum dammar:

| | |
|---|---|
| Aradur 350 BD | 43.00 |
| Sulphurised gum dammar | 43.00 |
| Pine oil (equalisation component) | 7.00 |

### EXAMPLE 7

| | |
|---|---|
| Aradur 350 BD | 43.00 |
| Caustic soda solution, 50% | 10.00 |
| Pine oil (equalisation component) | 47.00 |

### EXAMPLE 8

The resin solutions thus produced (examples 5 to 7) are incorporated into the following recipes for porcelain:

Production process:

| | | |
|---|---|---|
| Gold sulphoresinate | (54% Au) | 22.20% |
| Silver sulphoresinate | (52% Ag) | 2.12% |
| Rhodium resinate, dissolved in pine oil | (5% Rh) | 1.0% |
| Silicon resinate, dissolved in pine oil | (10% Si) | 2° /a |
| Bismuth resinate | (1O% Bi) | 1.0% |
| Pine oil (made up to 100%) | | |
| Sulphurised gum dammar | | 2.0% |

The components detailed above are gelled at 120° C. After cooling, the resin is added and homogenised:
Polyaminoamide resin (example 5, 6 or 7) 20.00%

The 3 mixtures of example 8 are printed with a 350 mesh fabric, dried and varnished with a varnish mask (polyester fabric 32, varnish L 406 from Heraeus) dried and subsequently applied and fired.

The pastes produced in this way are excellent regarding their storage stability (this is tested in a high speed test in the drying cabinet at 80° C.) and they are processable even after storage for several years.

1. Noble metal preparation or lustre preparation comprising at least one polyaminoamide.

2. Noble metal preparation or lustre preparation according to claim 1, wherein the amino functions of the polyaminoamide have been inactivated.

3. Noble metal preparation or lustre preparation according to claim 2, wherein the amino functions of the polyaminoamide have been protonated.

4. Noble metal preparation or lustre preparation according to claim 1, comprising additionally one or several substance(s) selected from the group consisting of metal resinates, organometallic compounds, natural resins, synthetic resins, resin oils, organic pigments and fillers, thixotroping agents, solvents and defoaming agents.

5. Noble metal preparation or lustre preparation according to claim 1, in which the polyaminoamide moiety amounts to 3 to 50% by weight of the preparation.

6. Ceramic decalcomania containing a noble metal preparation or lustre preparation according to claim 1.

7. An indirect or direct screen printing method comprising indirectly or directly screen printing a noble metal preparation or luster preparation according to claim 1 onto a silicate surface.

8. The method according to claim 7, wherein the silicate surface is ceramics, glass or porcelain.
